(19) United States
(12) Patent Application Publication
(10) Pub. No.: US 2013/0313185 A1
(43) Pub. Date: Nov. 28, 2013

(54) FORWARD OSMOSIS MEMBRANE AND METHOD OF MANUFACTURE

(71) Applicants: Tai-Shung Chung, Singapore (SG); Kaiyu Wang, Singapore (SG)

(72) Inventors: Tai-Shung Chung, Singapore (SG); Kaiyu Wang, Singapore (SG)

(21) Appl. No.: 13/984,454

(22) PCT Filed: Feb. 13, 2012
(86) PCT No.: PCT/SG12/00042

§ 371 Date: Aug. 8, 2013

Related U.S. Application Data
(60) Provisional application No. 61/422,328, filed on Dec. 13, 2010.

(51) Int. Cl. B01D 71/56; B01D 67/00; B01D 71/64; B01D 71/12; B01D 71/68; B01D 71/42

(52) U.S. Cl. CPC B01D 71/56; B01D 71/68; B01D 71/42; B01D 71/64; B01D 71/12; B01D 67/0011
USPC 210/490

(57) ABSTRACT

A forward osmosis membrane (10) and method (50) of forming the forward osmosis membrane (10) are provided. The forward osmosis membrane (10) has an integral hydrophilic asymmetric layer (12). The integral hydrophilic asymmetric layer (12) includes a first sublayer (18) having a plurality of first elongated pores (20) extending along a depth of the first sublayer (18) and a second sublayer (22) having a plurality of second elongated pores (24) extending along a thickness of the second sublayer (22). The first elongated pores (20) are dimensionally smaller than the second elongated pores (24). A polyamide layer (14) is formed over a surface of the integral hydrophilic asymmetric layer (12).

### FIELD OF THE INVENTION

The present invention relates to membrane technology and more particularly to a forward osmosis membrane and a method of manufacturing the same.

### BACKGROUND OF THE INVENTION

Water scarcity poses a serious constraint to sustainable development, particularly in drought-prone and environmentally polluted areas. To alleviate the problem of water scarcity, efforts have been made to develop technologies for seawater desalination and wastewater reclamation that consume reduced amounts of energy.

One such area of technology is membrane technology. Membrane based separation processes have advantages of avoiding thermally imposed efficiency limitations on heat consumption compared to thermal separation techniques. Membrane processes are commonly distinguished based on the main driving forces that are employed to accomplish the separation.

Forward (direct) osmosis (FO) processes, employing osmotic pressures as the driving force, represent an emerging membrane technology with low energy cost that has attracted considerable attention in various fields including wastewater treatment, seawater desalination, pharmaceutical applications, juice concentration, power generation, and protein enrichment. The forward osmosis process utilizes semi-permeable membranes to separate water from dissolved solutes. In a forward osmosis process, the osmotic pressure gradient between the concentrated draw solution and the saline feed supplies a spontaneous driving force for the transportation of water. The driving force of osmotic pressures used in forward osmosis processes can be significantly higher than that of hydraulic pressures used in reverse osmosis (RO) processes, resulting in a higher theoretical water flux. Moreover, forward osmosis processes can offer the advantages of higher rejection to a wide range of contaminants and lower membrane-fouling propensities compared to traditional pressure-driven membrane processes.

However, a fundamental hurdle that deters the successful implementation of forward osmosis processes is the lack of desirable membranes with appropriate separation performances.

It is therefore desirable to have a forward osmosis membrane that exhibits higher rejection of ions and a higher water flux during forward osmosis processes and a method of manufacturing the same.

### SUMMARY OF THE INVENTION

Accordingly, in a first aspect, the present invention provides a forward osmosis membrane having an integral hydrophilic asymmetric layer. The integral hydrophilic asymmetric layer includes a first sublayer having a plurality of first elongated pores extending along a depth of the first sublayer and a second sublayer having a plurality of second elongated pores extending along a thickness of the second sublayer. The first elongated pores are dimensionally smaller than the second elongated pores. A polyamide layer is formed over a surface of the integral hydrophilic asymmetric layer.

In a second aspect, the present invention provides a method of forming a forward osmosis membrane. The method includes preparing a polymer solution, the polymer solution including a polymer, a hydrophilic polymer additive, a solvent and a pore forming agent. The polymer solution is cast on a surface to form a liquid film. The liquid film is contacted with a coagulation medium to form an integral asymmetric membrane. A surface of the integral asymmetric membrane is contacted with a monomeric aromatic polyamine in an aqueous solution and the surface of the integral asymmetric membrane is then contacted with a polyfunctional acyl halide in a polar organic solvent to form a composite membrane.

Other aspects and advantages of the invention will become apparent from the following detailed description, taken in conjunction with the accompanying drawings, illustrating by way of example the principles of the invention.

### BRIEF DESCRIPTION OF THE DRAWINGS

Embodiments of the invention will now be described, by way of example only, with reference to the accompanying drawings, in which:

FIG. 1 is a schematic, enlarged cross-sectional view of a forward osmosis membrane in accordance with one embodiment of the present invention;

FIG. 2 is a flowchart illustrating a method of forming the forward osmosis membrane of FIG. 1;

FIG. 3A is a scanning electron microscope image of a cross-section of an integral hydrophilic asymmetric layer of a membrane in accordance with one embodiment of the present invention;

FIG. 3B is a scanning electron microscope image of a cross-section of a first sublayer in the integral hydrophilic asymmetric layer of FIG. 3A;

FIG. 3C is a scanning electron microscope image of a top surface of the membrane of FIG. 3A;

FIG. 3D is a scanning electron microscope image of a bottom surface of the membrane of FIG. 3A;

FIG. 4A is a scanning electron microscope image of a cross-section of a thin film composite membrane in accordance with one embodiment of the present invention;

FIG. 4B is a scanning electron microscope image of a further enlarged cross-section near a top layer of the thin film composite membrane of FIG. 4A;

FIG. 4C is a scanning electron microscope image of a top surface of the thin film composite membrane of FIG. 4A;

FIG. 4D is a scanning electron microscope image of a bottom surface of the thin film composite membrane of FIG. 4A;

FIG. 5 is a schematic block diagram of a forward osmosis setup using the thin film composite membrane of FIG. 4A;

FIG. 6A is a plot of water permeation flux through the thin film composite membrane of FIG. 4A against NaCl concentration in the draw solution;

FIG. 6B is a plot of reverse salt flux through the thin film composite membrane of FIG. 4A against NaCl concentration in the draw solution; and

FIG. 7 is a plot of water permeation flux against NaCl concentration in the feed.

### DETAILED DESCRIPTION OF EXEMPLARY EMBODIMENTS

The detailed description set forth below in connection with the appended drawings is intended as a description of presently preferred embodiments of the invention, and is not intended to represent the only forms in which the present invention may be practiced. It is to be understood that the same or equivalent functions may be accomplished by different embodiments that are intended to be encompassed within the scope of the invention.

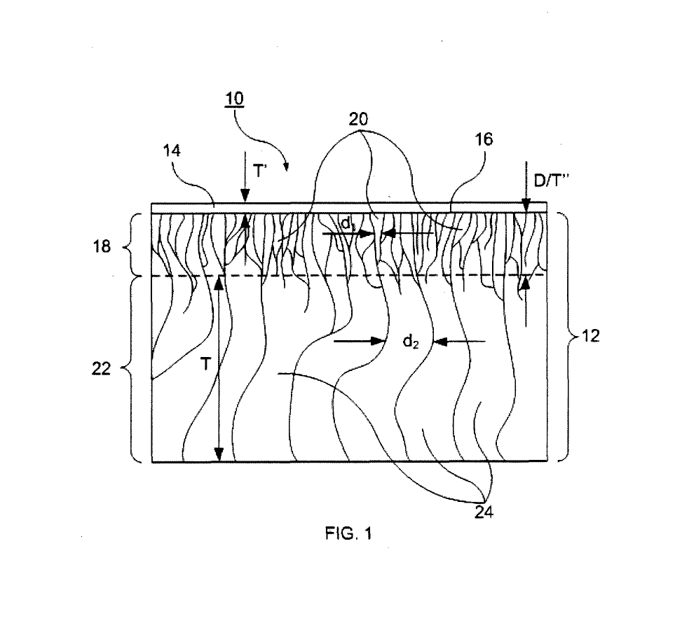

Referring now to FIG. 1, a schematic, enlarged cross-sectional view of a forward osmosis membrane 10 is shown. The forward osmosis membrane 10 includes an integral hydrophilic asymmetric layer 12 and a polyamide layer 14 formed over a surface 16 of the integral hydrophilic asymmetric layer 12. The integral hydrophilic asymmetric layer 12 includes a first sublayer 18 having a plurality of first elongated pores 20 extending along a depth D of the first sublayer 18 and a second sublayer 22 having a plurality of second elongated pores 24 extending along a thickness T of the second sublayer 22. As can be seen from FIG. 1, the first elongated pores 20 are dimensionally smaller than the second elongated pores 24.

Examples of applications in which the forward osmosis membrane 10 may be used include salt water desalination, osmotic concentration of foods, pharmaceutical applications and membrane reactors. The forward osmosis membrane 10 may be formed as a flat sheet, a hollow fiber or in a tubular configuration.

In one embodiment, the forward osmosis membrane 10 has a pure water permeability of between about 0.4 litres per square metre of membrane per hour at a transmembrane pressure of 1 bar (L/m² h bar) and about 5.0 L/m² h bar. In the same or a different embodiment, the integral hydrophilic asymmetric layer 12 has a pure water permeability of between about 100 L/m² h bar and about 1000 L/m² h bar.

In one embodiment, the integral hydrophilic asymmetric layer 12 has an overall porosity of between about 50 percent (%) and about 85%. In the same or a different embodiment, the integral hydrophilic asymmetric layer 12 has an effective mean pore diameter of between about 2 nanometres (nm) and about 50 nm, and more preferably between about 5 nm and about 25 nm.

The polyamide layer 14 may include one or more polyamide structures selected from a group comprising —NH—CO—, —NH—CO—Ar—COOH (where Ar is an aromatic group),

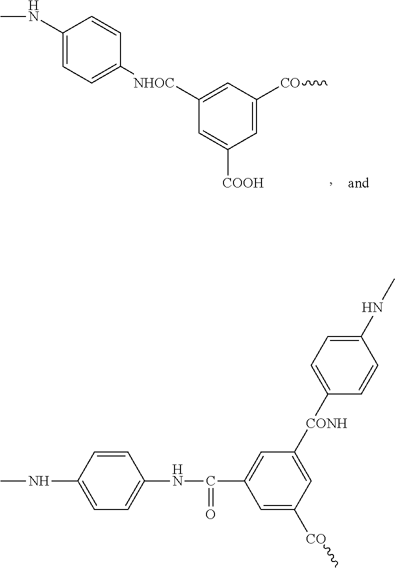

In one embodiment, the polyamide layer 14 has a thickness T′ of between about 50 nanometres (nm) and about 500 nm. In such an embodiment, the forward osmosis membrane 10 is a thin-film composite membrane.

In one embodiment, the first sublayer 18 extends to a depth D or has a thickness T″ of between about 1.0 microns (μm) and about 5.0 μm. In the same or a different embodiment, the second sublayer 22 has a thickness T of between about 50 μm and about 200 μm.

In one embodiment, the first elongated pores 20 have a mean pore diameter d₁ of between about 0.5 μm and about 5.0 μm. In the same or a different embodiment, the second elongated pores 24 have a mean pore diameter d₂ of between about 5 μm and about 25 μm.

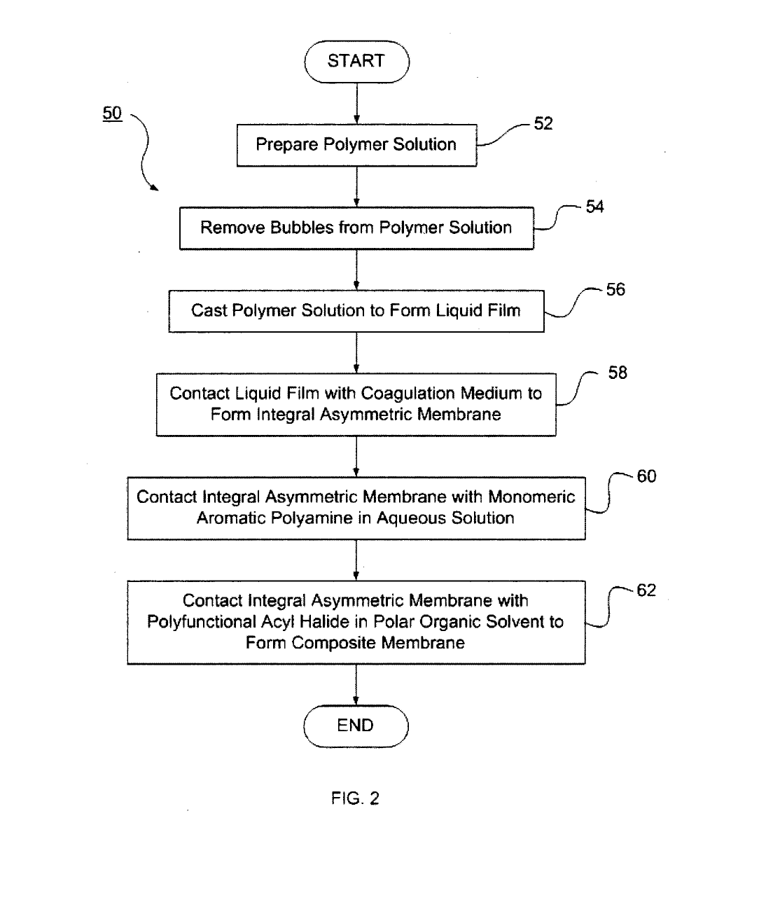

Referring now to FIG. 2, a method 50 of forming the forward osmosis membrane 10 of FIG. 1 will now be described. The method 50 begins at step 52 with the preparation of a polymer solution. The polymer solution includes a polymer, a hydrophilic polymer additive, a solvent and a pore forming agent. In one embodiment, a weight ratio of the hydrophilic polymer additive to the polymer in the polymer solution is in a range of from about 1:10 to about 1:1.

The polymer may be polyethersulfone, polysulfone, polyacrylonitrile, polyetherimide, polyamide-imide, cellulose acetate, poly(phenylene oxide) or a combination thereof.

The hydrophilic polymer additive may be sulfonated polyethersulfone, sulfonated polysulfone, polybenzimidazole, polyvinyl alcohol, sulfonated poly(phenylene oxide) or a combination thereof.

The solvent may be N,N-dimethylacetamide, dimethylsulfoxide, dimethylformamide, N-methyl-pyrrolidone, triethylphosphate, tetrahydrofuran, 1,4-dioxane, methyl ethyl ketone or a combination thereof.

The pore forming agent may be ethylene glycol, diethylene glycol, glycerol, methanol, ethanol, isopropanol or a combination thereof.

At step 54, a plurality of bubbles is removed from the polymer solution prior to casting the polymer solution at step 56 on a surface to form a liquid film.

At step 58, the liquid film is contacted with a coagulation medium to form an integral asymmetric membrane. This may be done by immersing the liquid film in a coagulant bath. In one embodiment, the coagulation medium is made up of a mixture of a second solvent and a non-solvent. In such an embodiment, the second solvent may be N,N-dimethylacetamide, dimethylsulfoxide, dimethylformamide, N-methyl-pyrrolidone, tetrahydrofuran, triethylphosphate, 1,4-dioxane, methyl ethyl ketone or a combination thereof, and the non-solvent may be water, methanol, ethanol, isopropanol or a combination thereof. In one such embodiment, a weight ratio of the second solvent to the non-solvent in the coagulation medium is in a range of from about 1:10 to about 10:1, and more preferably in a range of from about 1:3 to about 3:1. Advantageously, the use of a mixed solvent/non-solvent coagulant system facilitates formation of a desired membrane microstructure that forms a skin layer and gives the membrane surface uniform pores and higher porosity.

In the present embodiment, the integral asymmetric membrane serves as a membrane substrate for the manufacture of a composite forward osmosis membrane. Because forward osmosis membranes contact two feed fluids simultaneously, the physicochemical properties of the membrane substrate (that is, hydrophilicity, porosity, pore size, pore size distribution, and substructure resistance) have a significant effect on the performance of the resultant membrane.

Advantageously, the introduction of an amount of sulfonated polymer into the membrane matrix helps adjust the hydrophilicity of the membrane substrate and helps maintain membrane stability. Further advantageously, a combination of relatively hydrophilic sulfonated polysulfone (undissolvable in water) blended with hydrophilic polyethersulfone helps enhance the wettability of the membrane substrate.

Consequent to the foregoing, a porous hydrophilic membrane support is produced in the present embodiment via wet-phase inversion of the polymer solution. The resultant membrane substrate has an asymmetric structure containing a thin, porous, sponge-like top layer and a porous middle layer full of finger-like macrovoids. The thin, porous, sponge-like top layer acts as a cushion to enhance the mechanical strength of the membrane substrate.

During a forward osmosis process, water is transported through the membrane based on a solution-diffusion mechanism, that is, water or solutes in the feed solution or the draw solution diffuse within the porous support layer. Therefore, the highly porous, hydrophilic support that is formed facilitates transportation of water and solutes and decreases membrane fouling.

At step 60, a surface of the integral asymmetric membrane is contacted with a monomeric aromatic polyamine in an aqueous solution. This may be done by soaking the porous hydrophilic support in an aqueous solution containing a monomeric aromatic polyamine reactant, then taking out the soaked hydrophilic membrane substrate and drying the membrane substrate by blowing with air.

In one embodiment, the monomeric aromatic polyamine in the aqueous solution has at least two (2) primary amine substituents on an aromatic nucleus of less than three (3) aromatic rings. The monomeric aromatic polyamine may be phenylenediamine, phenylenetriamine, cyclohexane triamine, cyclohexane diamine, piperazine, bipiperidine or any other aromatic compound having —NH₂— or —NH— groups.

In the same or a different embodiment, a concentration of the monomeric aromatic polyamine in the aqueous solution is in a range of from about 0.1 weight 5 percent (wt %) to about 5.0 wt %.

At step 62, the surface of the integral asymmetric membrane is contacted with a polyfunctional acyl halide in a polar organic solvent to form a composite membrane.

The polyfunctional acyl halide may be

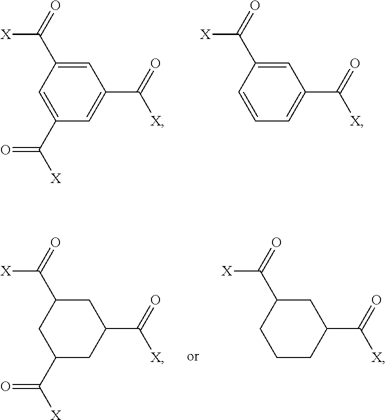

where X represents a halide. The halide may be fluoride (F), chloride (Cl), bromide (Br) or iodide (I).

The polar organic solvent may be an alkane and/or a cycloalkane such as, for example, hexane, heptane, cyclohexane, isopar, benzene or a combination thereof.

In one embodiment, a concentration of the polyfunctional acyl halide in the polar organic solvent is in a range of from about 0.01 wt % to about 5.0 wt %. In the same or a different embodiment, the surface of the integral asymmetric membrane is contacted with the polyfunctional acyl halide in the polar organic solvent for a period of between about 5 to about 120 seconds (s).

A thin-film composite membrane is synthesized via the in-situ interfacial polymerization reaction between two monomer solutions: the aqueous polyfunctional amine solution and the polyfunctional acyl halide dissolved in the polar organic solvent. An exemplary reaction scheme to form the thin-film composite membrane is shown below:

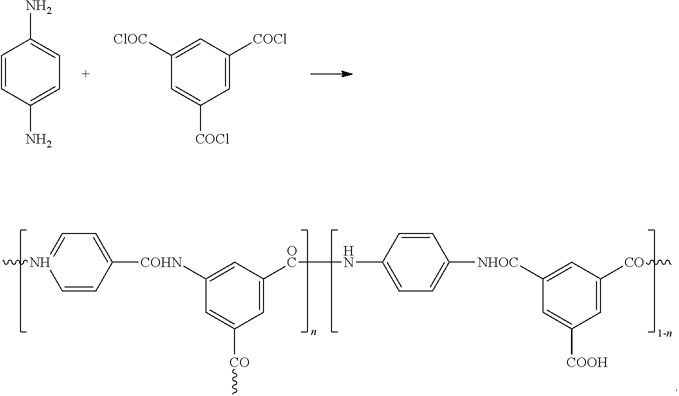

Due to the solubility preferences of the monomers in the two different immiscible phases, namely the organic and aqueous phases, the interfacial polymerization reaction generally takes place very quickly on the organic side and produces a defect free, ultrathin film at the interlace. Advantageously, this significantly reduces the membrane production cost.

Thin-film composite membranes have key advantages over conventional cellulose acetate based asymmetric membranes, namely higher water permeability whilst maintaining greater solute rejections due to the ultra-thin active layer (approximately 100 nm) over the porous substrates, and also non-biodegradability. The expected higher water flux of thin-film composite forward osmosis membranes is partially attributed to higher hydrophilicity of the aromatic polyamides that arises from the carboxylic acid structure from the hydrolysis of the acyl halide groups.

The physicochemical property of the membrane substrate is a key factor in the formation of thin-film composite forward osmosis membranes as it influences the rate and extent of the interfacial polymerization reaction by controlling the amount of aromatic polyamine diffusing to the reaction interface, the breadth of the reaction interface, and the polyamide layer thickness formed inside the pores.

After the in situ reaction on the substrate surface, the resultant membrane may be dried at a temperature of between about 20 degrees Celsius (° C.) and about 125° C., more preferably between about 25° C. and about 60° C., for a period of between about 1 minute (min) to about 30 min, and then kept in water until subsequent use.

Experiments conducted on the synthesized thin-film composite forward osmosis membranes show that the membranes exhibit higher rejections to ions and a higher water flux during the forward osmosis process. More particularly, the thin-film composite membranes showed higher rejection of divalent ions (MgCl₂, MgSO₄) and lower rejection of monovalent ions (NaCl) under hydraulic pressures and achieved a higher water flux of 69.8 litres per square metre of membrane per hour (L/m² h) against DI water and 25.2 L/m² h against a 3.5 weight percent (wt %) sodium chloride (NaCl) solution under 5.0 molar (M) NaCl as the draw solution in the pressure-retarded osmosis (PRO) mode.

### EXAMPLE 1

### Fabrication of a Hydrophilic Polyethersulfone/Sulfonated Polysulfone Substrate

15.4 percent weight per volume (% w/v) of polyethersulfone (PES) and 2.2% w/v sulfonated polysulfone (SPSf, self-made with the ion-exchange capacities (IEC) of 0.65 milliequivalents of charge per gram (mEq/g)) were dissolved in N-methyl-2-pyrrolidone (NMP, >99.5%) with 12.4 weight percent (wt %) diethylene glycol (DG) to form a casting solution.

The PES/SPSf alloyed substrate was prepared by the Loeb-Sourirajan wet phase inversion method.

The casting solution was placed overnight at 25° C. to remove bubbles and then cast on a flat glass plate to form a liquid film with a uniform thickness. The liquid film was then immersed into a mixture of NMP/deionised (DI) water (50/50 wt %) to form a porous substrate with a thickness of 60-100 micron (μm). After being peeled off from the glass plate, the membrane was rinsed with tap water for 6 hours (h) to remove residual solvents.

A selective top skin layer was formed during the phase inversion.

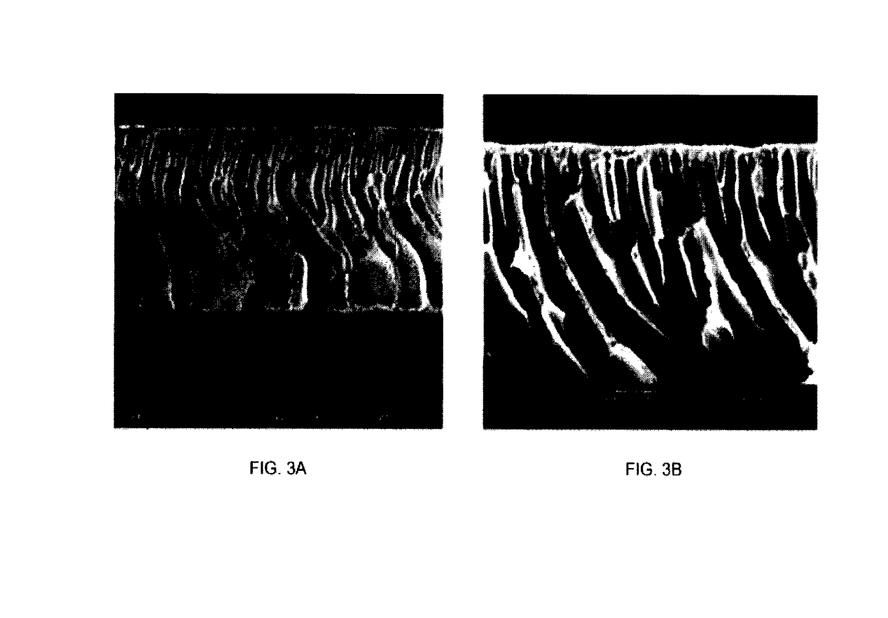

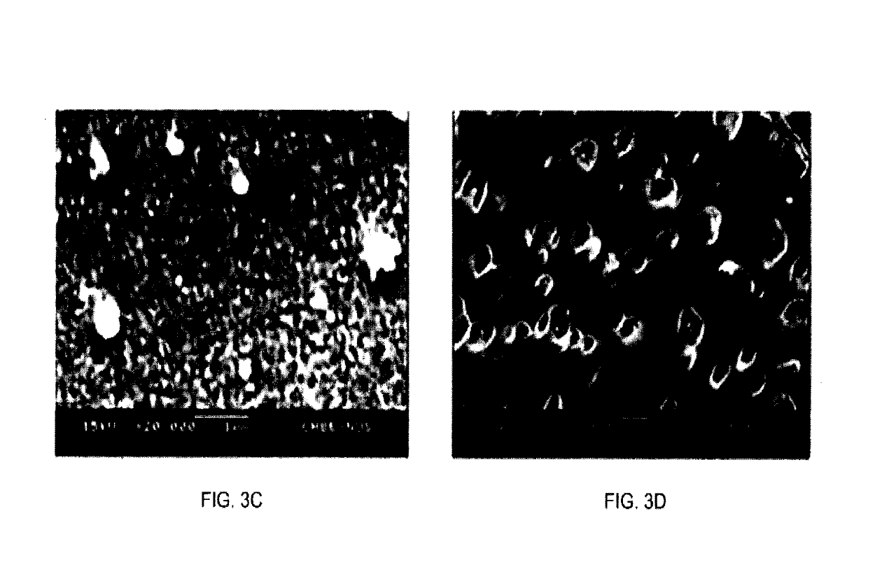

Images of the membrane taken with a scanning electron microscope are shown in FIGS. 3A, 3B, 3C and 3D. The morphology of the PES/SPSf alloyed membrane substrate can be seen from FIGS. 3A, 3B, 3C and 3D.

Referring now to FIG. 3A, a scanning electron microscope image of a cross-section of an integral hydrophilic asymmetric layer of the membrane is shown. The asymmetric membrane structure includes a thin sponge-like top layer (1.2±0.1 micron in thickness), a porous middle layer full of finger-like macrovoids (93.5±7.5 micron in thickness) and a thin bottom layer (approximately 1.0 micron in thickness). The overall porosity of the PES/SPSf substrate is about 0.833. An enlarged, cross-sectional view of the sponge-like top layer is shown in FIG. 3B.

A scanning electron microscope image of a top surface of the membrane is shown in FIG. 3C and a scanning electron microscope image of a bottom surface of the membrane is shown in FIG. 3D. The effective mean pore diameter of the PES/SPSf substrate is 15.9 nm. The larger pores on the bottom surface connect with the finger-like macrovoids to help mitigate the effects of internal concentration polarization within the porous support layer. The PES/SPSf substrate has a pure water permeability of 505.2 L/m² h bar.

### EXAMPLE 2

### Fabricating a Thin-Film Composite Forward Osmosis Membrane on the Hydrophilic PES/SPSf Substrate

A polyamide thin-film composite forward osmosis membrane was fabricated by firstly immersing the fabricated PES/SPSf membrane substrate in an aqueous 2.0% w/v p-phenylenediamine (PPDA) solution for 120 s. Only one side of the membrane substrate was in contact with the PPDA solution. After removal from the solution, excess PPDA drops were removed from the support surface with tissue paper followed by blowing with air. Thereafter, 0.15% w/v 1,3,5-benzenetricarbonyl trichloride or trimesoylchloride (TMC) dissolved in heptane was poured on the surface of the PPDA soaked membrane substrate for 30 s, leading to the formation of an ultra-thin, salt selective, crosslinked polyamide film over the substrate. The resultant membrane was washed with ethanol to remove organic solvent residue and then dried in air at 25° C. for 30 min. Subsequent to that, the resultant membrane was thoroughly washed with deionised water to remove residual PPDA and then stored in deionised water for further characterization. There was no thermal curing of the resultant composite membrane in order to prevent the membrane from dehydration which can result in air bubbles being trapped inside the membrane support layer.

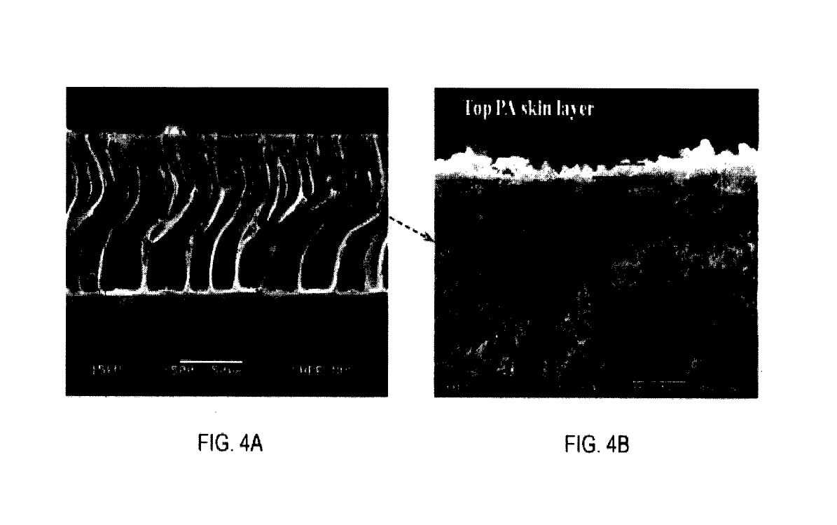

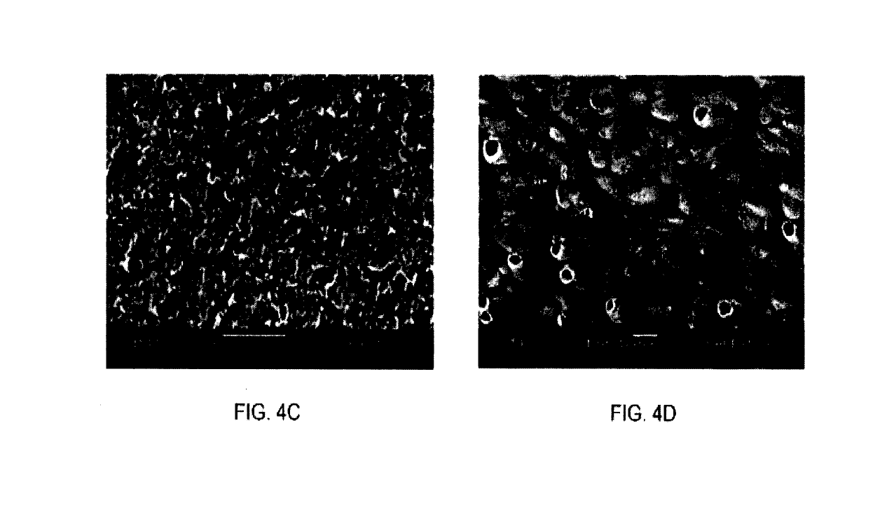

Images of the thin-film composite forward osmosis membrane taken with a scanning electron microscope are shown in FIGS. 4A, 4B, 4C and 4D. The morphology of the thin-film composite forward osmosis membrane can be seen from FIGS. 4A, 4B, 4C and 4D.

Referring now to FIGS. 4A and 4B, a scanning electron microscope image of a cross-section of the thin-film composite forward osmosis membrane is shown in FIG. 4A and a further enlarged, cross-section near a top layer of the thin-film composite forward osmosis membrane is shown in FIG. 4B. As can be seen from FIG. 4B, after the interfacial polymerization reaction on the top surface of the membrane substrate, a thin active polyamide layer having an average thickness of 150 nm is formed with a ridge-and-valley morphology.

A scanning electron microscope image of a top surface of the thin-film composite forward osmosis membrane is shown in FIG. 4C and a scanning electron microscope image of a bottom surface of the thin-film composite forward osmosis membrane is shown in FIG. 4D.

The thin-film composite forward osmosis membrane that was formed had a pure water permeability of 0.77 L/m² h bar, and a salt rejection rate of 96.5 percent (%) sodium chloride (NaCl) at a pressure of 10 bar.

### EXAMPLE 3

### Water and Salt Transport through the Thin Film Composite Membrane

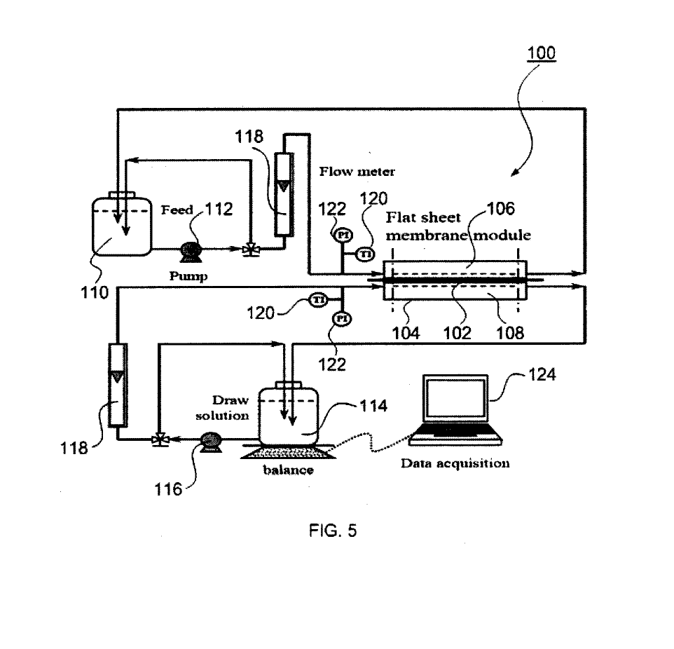

Referring now to FIG. 5, a schematic block diagram of a forward osmosis setup 100 employing the thin-film composite membrane 102 of FIG. 4A is shown. The forward osmosis setup 100 includes a crossflow cell 104 of a plate and frame design with a rectangular cell channel 106 and 108 on each side of the membrane 102. A feed solution 110 is circulated via a first pump 112 through a first cell channel 106 and a draw solution 114 is circulated via a second pump 116 through a second cell channel 108. Flow meters 118, temperature indicators 120 and pressure indicators 122 are provided to measure the flows and temperatures of the feed and draw solutions 110 and 114 and the pressures at the two channel inlets. A computing device 124 is provided for data acquisition.

Water flux during the forward osmosis process is determined by measuring the volume change of the feed solution 110 over a predetermined period. Co-current cross flows of the feed and draw solutions 110 and 114 are used.

The flow velocity during the testing is 8.3 centimetres per second (cm/s) for both the feed and draw solutions 110 and 114 which flow co-currently through the first and second cell channels 106 and 108. The temperatures of the feed and draw solutions 110 and 114 are maintained at 22±0.5° C. and the pressures at the two channel inlets are kept at 1.0 pound per square inch (psi).

The draw solutions 114 are prepared from NaCl solutions with different concentrations. When using pure water as the feed, the salt leakage is calculated by measuring the conductivity in the feed solution 110 at the end of the experiment. The water permeation flux (Jᵥ) is calculated from the feed volume change:

Jᵥ=ΔV/(AΔt) (1)

where ΔV measured in litres (L) is the permeation water collected over a predetermined period of time Δt measured in hours (hr) during the forward osmosis process and A is the effective membrane surface area measured in square metres (m²).

The salt concentration in the feed water is determined from the conductivity measurement using a calibration curve for the single salt solution. The salt leakage, salt back-flow from the draw solution 114 to the feed, Jₛ, measured in grams per square metre per hour (g/(m² h)), is thereafter determined from the increase of the feed conductivity:

Jₛ=Δ(CₜVₜ)/(AΔt) (2)

where Cₜ and Vₜ are the salt concentration and the volume of the feed at the end of forward osmosis tests, respectively.

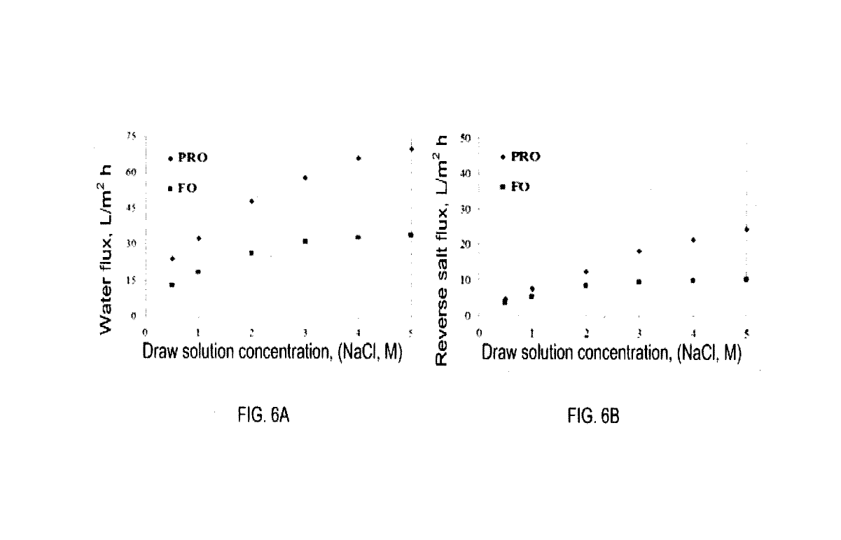

Referring now to FIGS. 6A and 6B, plots of water permeation flux and reverse salt flux through the thin film composite membrane 102 against NaCl concentration in the draw solution are shown. As can be seen from FIGS. 6A and 6B, the water flux goes up with an increase in the draw NaCl concentration, while the salt leakages are satisfactorily low under any circumstances. The water flux can achieve 69.8 litres per square metre of membrane per hour (L/m² h) in a pressure-retarded osmosis (PRO) mode using 5.0 molar (M) NaCl as the draw solution, which is much higher than that in the forward osmosis (FO) mode.

### EXAMPLE 4

### Sea Water Desalination Using the Thin Film Composite Membrane

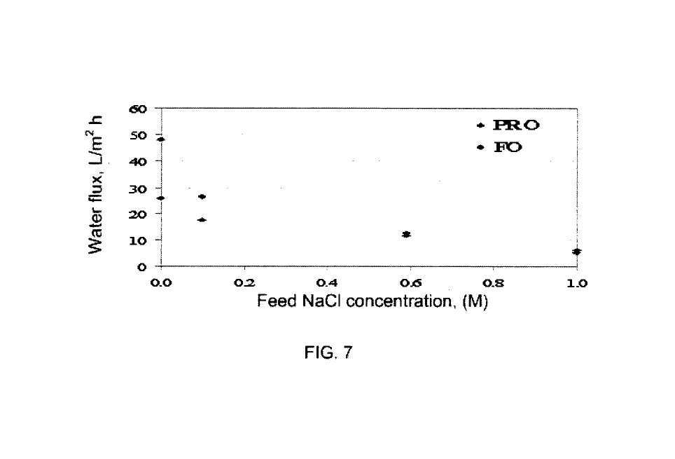

Referring now to FIG. 7, a plot of water permeation flux against NaCl concentration in the feed is shown. More particularly, FIG. 7 shows the water flux performance for the desalination of salt water using the thin film composite membrane under different membrane orientations. The water flux in the pressure-retarded osmosis (PRO) mode is higher than that in the forward osmosis (FO) mode at the same draw concentration. There is a water flux of 12.7 L/m² h under 2.0 M NaCl as the draw solution and 3.5 wt % seawater as the feed.

### COMPARATIVE EXAMPLE 5

### Fabrication of a Polyethersulfone Substrate Based Thin-Film Composite Forward Osmosis Membrane for Comparison

17.5% w/v of polyethersulfone (PES) is dissolved in N-methyl-2-pyrrolidone (NMP, >99.5%) with 12.4 wt % diethylene glycol (DG) to form a casting solution.

The procedure of Example 1 was followed exactly to fabricate a porous PES substrate having an effective mean pore size of 12.8 nm in diameter and a pure water permeability of 411.4 L/m² h bar.

The procedure of Example 2 was also followed to conduct the interfacial polymerization reaction on the substrate surface.

When the resultant PES thin-film composite forward osmosis membrane was tested according to the conditions in Example 3, it showed lower water fluxes of 32.8 and 21.3 L/m² h, but higher salt leakages of 44.7 and 36.5 g/(m² h) at the pressure-retarded osmosis (PRO) and forward osmosis (FO) modes, respectively, under 2.0 M NaCl as the draw solution.

As is evident from the foregoing discussion, the present invention discloses a scheme to fabricate high performance membranes for forward osmosis (FO) applications through interfacial polymerization (IP) reactions on porous hydrophilic polymeric substrates. Through the interfacial polymerization reaction, an ultrathin active layer is formed that produces high water flux and salt rejection. Additionally, through the use of the modified hydrophilic substrates, the membranes do not require further thermal treatment under high temperature after the interfacial polymerization reaction. This helps reduce the fabrication cost of the membranes. Further advantageously, membrane fouling is also reduced with the combination of the hydrophilic polyamide active layer and the hydrophilic support layer. The membranes are particularly suitable for seawater desalination, water reclamation, and the osmotic concentration of foods and pharmaceutical solutions.

While preferred embodiments of the invention have been illustrated and described, it will be clear that the invention is not limited to these embodiments only. Numerous modifications, changes, variations, substitutions and equivalents will be apparent to those skilled in the art without departing from the scope of the invention as described in the claims.

Further, unless the context dearly requires otherwise, throughout the description and the claims, the words “comprise”, “comprising” and the like are to be construed in an inclusive as opposed to an exclusive or exhaustive sense; that is to say, in the sense of “including, but not limited to”.

1-37. (canceled)

38. A forward osmosis membrane comprising:
an integral hydrophilic asymmetric layer containing a first sublayer that has a plurality of first elongated pores extending along a depth of the first sublayer and a second sublayer that has a plurality of second elongated pores extending along a depth of the second sublayer, the first elongated pores being dimensionally smaller than the second elongated pores; and
a polyamide layer formed over a surface of the integral hydrophilic asymmetric layer.

39. The forward osmosis membrane of claim 38, wherein the first sublayer has a thickness of 1.0 μm to 5 μm, the first elongated pores have a mean pore diameter of 0.5 μm to 5 μm, the second sublayer has a thickness of 50 μm to 200 μm, and the second elongated pores have a mean pore diameter of 5 μm to 25 μm.

40. The forward osmosis membrane of claim 39, wherein
the forward osmosis membrane has a pure water permeability of 0.4 L/m²·h·bar to 5 L/m²·h·bar;
the integral hydrophilic asymmetric layer has an overall porosity of 50% to 85%, an effective mean pore diameter of 2 nm to 50 nm, and a pure water permeability of 100 L/m²·h·bar to 1000 L/m²·h·bar; and
the polyamide layer, having a thickness of 50 nm to 500 nm, contains one or more polyamide moieties selected from the group consisting of —NH—CO—, —NH—CO—Ar—COOH, 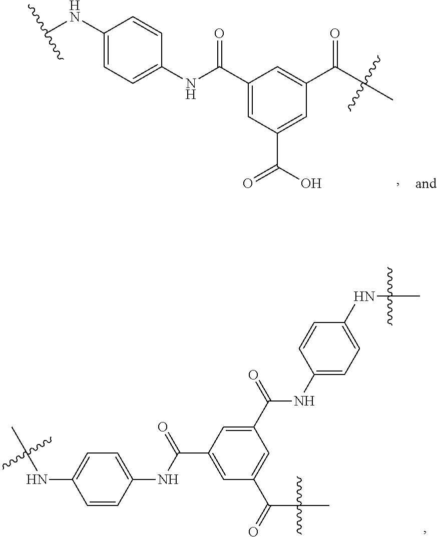 [SMILES: *Nc1ccc(NC(=O)c2cc(C(*)=O)cc(C(=O)O)c2)cc1 ; "," ; "and" ; *Nc1ccc(NC(=O)c2cc(C(*)=O)cc(C(=O)Nc3ccc(N*)cc3)c2)cc1 ; ","]
Ar being an aromatic group.

41. The forward osmosis membrane of claim 38, wherein the integral hydrophilic asymmetric layer has an overall porosity of 50% to 85%, an effective mean pore diameter of 2 nm to 50 nm, and a pure water permeability of 100 L/m²·h·bar to 1000 L/m²·h·bar.

42. The forward osmosis membrane of claim 41, wherein
the forward osmosis membrane has a pure water permeability of 0.4 L/m²·h·bar to 5 L/m²·h·bar; and
the polyamide layer, having a thickness of 50 nm to 500 nm, contains one or more polyamide moieties selected from the group consisting of —NH—CO—, —NH—CO—Ar—COOH, 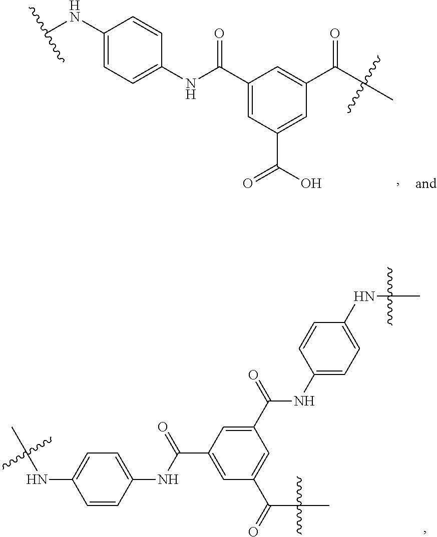 [SMILES: *Nc1ccc(NC(=O)c2cc(C(*)=O)cc(C(=O)O)c2)cc1 ; "," ; "and" ; *Nc1ccc(NC(=O)c2cc(C(*)=O)cc(C(=O)Nc3ccc(N*)cc3)c2)cc1 ; ","]
Ar being an aromatic group.

43. The forward osmosis membrane of claim 41, wherein the integral hydrophilic asymmetric layer, having an effective mean pore diameter of 5 nm to 25 nm, is formed from a polymer solution containing a polymer and a hydrophillic polymer additive,
in which,
the polymer is selected from the group consisting of polyethersulfone, polysulfone, polyacrylonitrile, polyetherimide, polyamide-imide, cellulose acetate, poly(phenylene oxide), and a combination thereof;
the hydrophilic polymer additive is selected from the group consisting of sulfonated polyethersulfone, sulfonated polysulfone, polybenzimidazole, polyvinyl alcohol, sulfonated poly(phenylene oxide), and a combination thereof; and
the weight ratio of the hydrophilic polymer additive to the polymer in the polymer solution is 1:10 to 1:1.

44. The forward osmosis membrane of claim 43, wherein
the forward osmosis membrane has a pure water permeability of 0.4 L/m²·h·bar to 5 L/m²·h·bar; and
the polyamide layer, having a thickness of 50 nm to 500 nm, contains one or more polyamide moieties selected from the group consisting of —NH—CO—, —NH—CO—Ar—COOH, 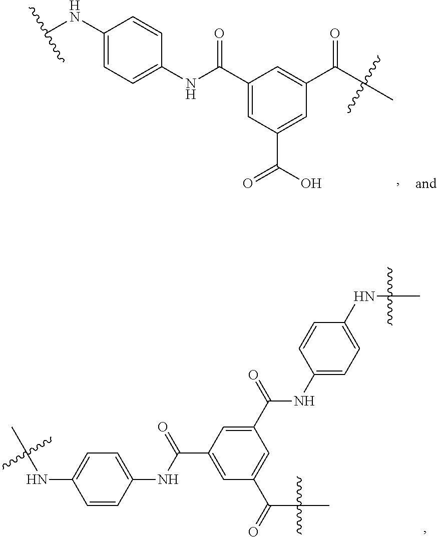 [SMILES: *Nc1ccc(NC(=O)c2cc(C(*)=O)cc(C(=O)O)c2)cc1 ; "," ; "and" ; *Nc1ccc(NC(=O)c2cc(C(*)=O)cc(C(=O)Nc3ccc(N*)cc3)c2)cc1 ; ","]
Ar being an aromatic group.

45. The forward osmosis membrane of claim 38, wherein the polyamide layer, having a thickness of 50 nm to 500 nm, contains one or more polyamide moieties selected from the group consisting of —NH—CO—, —NH—CO—Ar—COOH, 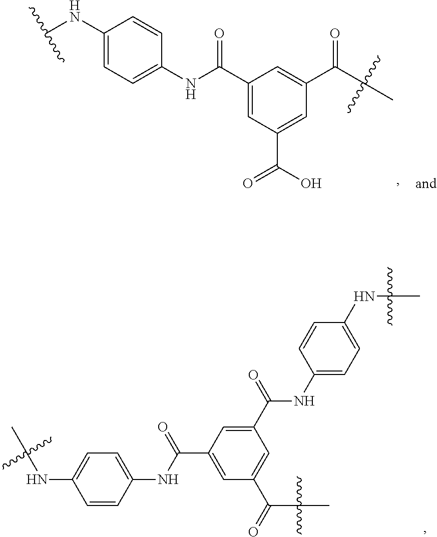 [SMILES: *Nc1ccc(NC(=O)c2cc(C(*)=O)cc(C(=O)O)c2)cc1 ; "," ; "and" ; *Nc1ccc(NC(=O)c2cc(C(*)=O)cc(C(=O)Nc3ccc(N*)cc3)c2)cc1 ; ","]
Ar being an aromatic group.

46. The forward osmosis membrane of claim 45, wherein the forward osmosis membrane has a pure water permeability of 0.4 L/m²·h·bar to 5 L/m²·h·bar.

47. The forward osmosis membrane of claim 38, wherein the forward osmosis membrane has a pure water permeability of 0.4 L/m²·h·bar to 5 L/m²·h·bar.

48. A method of forming a forward osmosis membrane, the method comprising:
preparing a polymer solution, the polymer solution containing a polymer, a hydrophilic polymer additive, a solvent and a pore forming agent;
casting the polymer solution on a surface to form a liquid film;
contacting the liquid film with a coagulation medium to form an integral asymmetric membrane;
contacting a surface of the integral asymmetric membrane with a monomeric polyamine in an aqueous solution; and
contacting the surface of the integral asymmetric membrane with a polyfunctional acyl halide in a polar organic solvent,
whereby a forward osmosis membrane is formed.

49. The method of claim 48, wherein
the polymer is selected from the group consisting of polyethersulfone, polysulfone, polyacrylonitrile, polyetherimide, polyamide-imide, cellulose acetate, poly(phenylene oxide), and a combination thereof;
the hydrophilic polymer additive is selected from the group consisting of sulfonated polyethersulfone, sulfonated polysulfone, polybenzimidazole, polyvinyl alcohol, sulfonated poly(phenylene oxide), and a combination thereof;
the solvent is selected from the group consisting of N,N-dimethylacetamide, dimethylsulfoxide, dimethylformamide, N-methyl-pyrrolidone, triethylphosphate, tetrahydrofuran, 1,4-dioxane, methyl ethyl ketone, and a combination thereof;
the pore forming agent is selected from the group consisting of ethylene glycol, diethylene glycol, glycerol, methanol, ethanol, isopropanol, and a combination thereof; and
the weight ratio of the hydrophilic polymer additive to the polymer in the polymer solution is 1:10 to 1:1.

50. The method of claim 49, wherein
the monomeric polyamine, having a concentration of 0.1 wt % to 5 wt % in the aqueous solution, is phenylenediamine, phenylenetriamine, cyclohexane triamine, cyclohexane diamine, piperazine, or bipiperidine;
the polyfunctional acyl halide, having a concentration of 0.01 wt % to 5 wt %, is 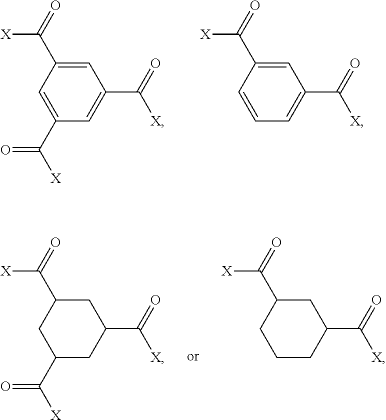
X being a halide; and
the polar organic solvent is an alkane, a cycloalkane, or a combination thereof.

51. The method of claim 50, wherein the surface of the integral. asymmetric membrane is contacted with the polyfunctional acyl halide in the polar organic solvent for a period of 5 seconds to 120 seconds.

52. The method of claim 48, further comprising removing a plurality of bubbles from the polymer solution prior to casting the polymer solution.

53. The method of claim 48, wherein the step of contacting the liquid film with the coagulation medium is performed by immersing the liquid film in the coagulant medium that contains a second solvent and a non-solvent, the second solvent being selected from the group consisting of N,N-dimethylacetamide, dimethylsulfoxide, dimethylformamide, N-methyl-pyrrolidone, tetrahydrofuran, triethylphosphate, 1,4-dioxane, methyl ethyl ketone, and a combination thereof; the non-solvent being selected from the group consisting of water, methanol, ethanol, isopropanol, and a combination thereof; and the weight ratio of the second solvent to the non-solvent in the coagulation medium is 1:10 to 10:1.

54. The method of claim 53, wherein the weight ratio of the second solvent to the non-solvent is 1:3 to 3:1.

55. The method of claim 48, wherein the monomeric polyamine contains at least two primary amine substituents on an aromatic nucleus of less than three aromatic rings.

56. The method of claim 48, wherein
the monomeric polyamine, having a concentration of 0.1 wt % to 5 wt % in the aqueous solution, is phenylenediamine, phenylenetriamine, cyclohexane triamine, cyclohexane diamine, piperazine, or bipiperidine;
the polyfunctional acyl halide, having a concentration of 0.01 wt % to 5 wt % in the polar organic solution, is 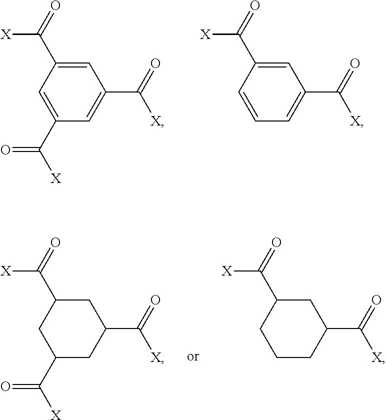
X being a halide; and
the polar organic solvent is an alkane, a cycloalkane, or a combination thereof.

57. The method of claim 48, wherein the surface of the integral asymmetric membrane is contacted with the polyfunctional acyl halide in the polar organic solvent for a period of 5 seconds to 120 seconds.
